(19) United States
(12) Patent Application Publication
(10) Pub. No.: US 2026/0066953 A1
(43) Pub. Date: Mar. 5, 2026

(54) RECONFIGURABLE INTELLIGENT SURFACES FOR THREE-DIMENSIONAL CELLULAR COVERAGE

(71) Applicant: Technology Innovation Institute - Sole Proprietorship LLC, Masdar City, Abu Dhabi (AE)

(72) Inventors: Georgios Alexandropoulos, Abu Dhabi (AE); Aymen Fakhreddine, Abu Dhabi (AE); Mérouane Debbah, Abu Dhabi (AE); Faouzi Bader, Abu Dhabi (AE)

(73) Assignee: Technology Innovation Institute - Sole Proprietorship LLC, Masdar City, Abu Dhabi (AE)

(21) Appl. No.: 19/106,720

(22) PCT Filed: Sep. 2, 2022
(86) PCT No.: PCT/GR2022/000045

§ 371 Date: Feb. 26, 2025

(51) Int. Cl. H04B 7/04; H04B 7/06

(52) U.S. Cl. CPC H04B 7/04013; H04B 7/06952

(57) ABSTRACT

A communication system is disclosed herein. The communication system includes a cellular base station and one or more reconfigurable intelligent surfaces. The cellular base station includes a downward facing antenna array and a first controller. The cellular base station is configured to communicate with a first user equipment above the cellular base station and a second user equipment below the base station. The reconfigurable intelligent surface is positioned below the cellular base station. The reconfigurable intelligent surface includes a reconfigurable panel of reflective elements and a second controller. The reconfigurable intelligent surface is configured to service the first user equipment by reflecting signals from the cellular base station to the first user equipment.

### FIELD OF THE DISCLOSURE

This disclosure relates to systems, methods, and computer-readable media for an enhanced communication system for servicing aerial vehicles and ground users using one or more reconfigurable intelligent surfaces.

### BACKGROUND

The use of drones or unmanned aerial vehicles (UAVs) is expanding into a wide range of applications such as, for example, goods delivery, urban air-taxis, remote surveillance, border control, agricultural monitoring, industrial monitoring, and disaster relief. Wireless connectivity is required for the transfer of data and sensor commands between the UAVs and external devices. Such connectivity needs to be reliable, secure, and capable to support high data rates. As such, it is desirable for the wireless communication link to be established using cellular network technology (e.g., 4G, 5G, and the upcoming 6G). However, legacy cellular network base stations are not well suited for establishing wireless links with UA Vs. This is because cellular base stations (CBS) are designed to serve ground users and the antennas of the base stations are therefore tilted downwards. Reconfiguring existing CBSs to service UAVs in an upwards direction, without also disrupting the service to ground users, would require a massive infrastructure change.

### SUMMARY

In some embodiments, a communication system is disclosed herein. The communication system includes a cellular base station and a reconfigurable intelligent surface. The cellular base station includes a downward facing antenna array and a first controller. The cellular base station is configured to communicate with a first user equipment above the cellular base station. The reconfigurable intelligent surface is positioned below the cellular base station. The reconfigurable intelligent surface includes a reconfigurable panel of reflecting elements and a second controller. The reconfigurable intelligent surface is configured to service the first user equipment by reflecting signals from the cellular base station to the first user equipment.

In some embodiments, a method of communicating with an aerial vehicle is disclosed herein. A cellular base station transmits a first signal to a reconfigurable intelligent surface positioned below the cellular base station. The reconfigurable intelligent surface reflects the first signal towards the aerial vehicle. The reconfigurable intelligent surface receives a second signal from the aerial vehicle. The reconfigurable intelligent surface reflects the second signal to the cellular base station.

### BRIEF DESCRIPTION OF THE DRAWINGS

To facilitate understanding, identical reference numerals have been used, where possible, to designate identical elements that are common to the figures. It is contemplated that elements dis-closed in one embodiment may be beneficially utilized on other embodiments without specific recitation.

FIG. 1 illustrates a conventional communication environment, according to example embodiments.

FIG. 2 illustrates an enhanced communication environment, according to example embodiments.

FIG. 3 illustrates an enhanced communication environment, according to example embodiments.

FIG. 4 is an illustrative schematic of an enhanced communication environment over time, according to example embodiments.

FIG. 5 is an illustrative schematic of an enhanced communication environment over time, according to example embodiments.

FIG. 6 is an illustrative schematic of an enhanced communication environment, according to example embodiments.

FIG. 7 is a flow diagram illustrating a method of communication between a cellular base station and an aerial vehicle, according to example embodiments.

FIG. 8A illustrates a system bus computing system architecture, according to example embodiments.

FIG. 8B illustrates a computer system having a chipset architecture, according to example embodiments.

To facilitate understanding, identical reference numerals have been used, where possible, to designate identical elements that are common to the figures. It is contemplated that elements dis-closed in one embodiment may be beneficially utilized on other embodiments without specific recitation.

### DETAILED DESCRIPTION

One or more techniques disclosed herein generally relate to one or more reconfigurable intelligent surfaces (RISs) for use with existing CBSs. Such RIS may allow aerial vehicles (AV) (both manned and unmanned), flying above the existing CBSs, to communicate with the existing CBSs, thereby extending the coverage of existing CBSs from the ground below the CBSs to the airspace above the CBSs. For example, the RIS can receive and redirect signals from an existing CBSs antenna to a vehicle flying above the existing CBSs. In this manner, higher altitude devices (i.e., above CBSs) are able to communicate with CBSs using the RIS.

As defined herein, an unmanned aerial vehicle (UAV) or drone is an aircraft without any human pilot, crew, or passengers on board. UAVs are controlled by a ground-based controller, which may be under the operation of a human operator.

As defined herein, a manned aerial vehicle (MAV) is an aircraft with a human, crew, or passengers on onboard. The MAV may be controlled via ground-based controller or by a pilot residing in the MAV. MAVs may operate under flight ceiling such that cellular communications can be transmitted between the MAV and CBSs using embodiments discussed herein. For example, an air taxi may be a MAV.

As defined herein, an AV can be a UAV or a MAV.

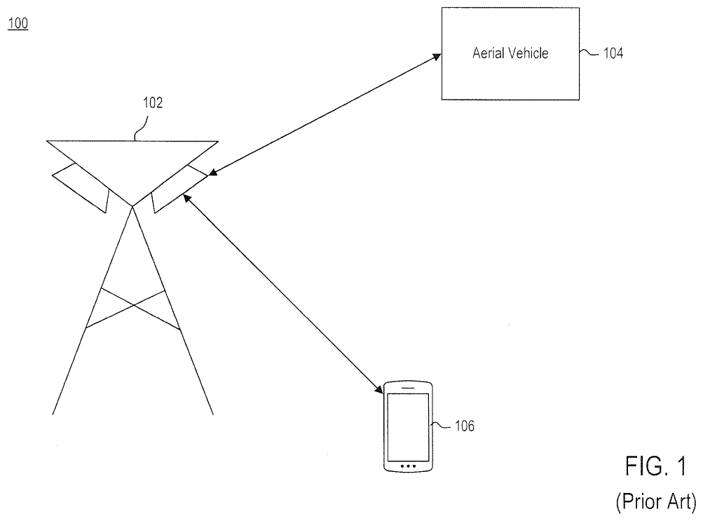

FIG. 1 illustrates a conventional communication environment 100, according to example embodiments. Communication environment 100 may include a CBS 102, an AV 104, and user equipment 106 of a ground user. In some embodiments, CBS 102 may be configured to communicate with AV 104. In such embodiments, communications from CBS 102 to AV 104 typically fail to meet the wireless connection requirements of AVs. This may be due, in part, the CBS 102 having downward facing antennas. As a result, CBS 102 is optimized, not for providing communications in an upward direction, but for communicating with entities beneath it, such as user equipment 106.

In some embodiments, CBS 102 may be configured to communicate with user equipment 106. User equipment 106 may be representative of any device capable of sending and/or receiving wireless communications from CBS 102. For example, user equipment 106 may be representative of a mobile device. Because user equipment is positioned below CBS 102, the downward facing antennas of CBS 102 are capable of meeting the wireless connection requirements of user equipment 106. Generally, CBS 102 may not be limited to only communicating with AV 104 and/or user equipment 106. For example, as shown, CBS 102 may be configured to simultaneously service AV 104 and user equipment 106. In such embodiments, CBS 102 may simultaneously send a first transmission to AV 104 and a second transmission to user equipment 106. In operation, CBS 102 may optimize a transmission to meet the quality of service (QOS) requests of the receiving device (e.g., AV 104, user equipment 106). If, for example, the QoS request of user equipment 106 is large (e.g., is close to the maximum as provided by CBS 102), the second transmission from CBS 102 to user equipment 106 may be disrupted by the first transmission to AV 104 because CBS 102 may concentrate power towards AV 104.

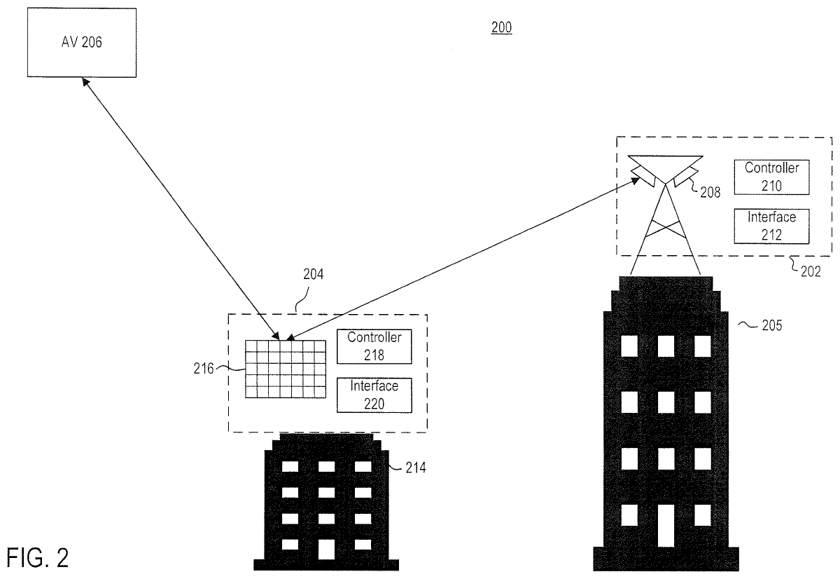

FIG. 2 illustrates an enhanced communication environment 200, according to example embodiments. Enhanced communication environment 200 may include CBS 202, an RIS 204, and an AV 206. As shown, CBS 202 may be positioned on a structure 205. In some embodiments, structure 205 may be representative of one or more of a building, a hill, a water tower, a billboard, and the like. Generally, CBS 202 may be positioned at some altitude above ground level so that CBS 202 may have line of sight of a plurality of devices on the ground.

CBS 202 may be representative of a conventional CBS. For example, for purposes of this discussion, CBS 202 may include at least an antenna array 208, a CBS controller 210, and an interface 212. Antenna array 208 may be representative of various types of antenna arrays. Antenna array 208 may be configured to transmit outgoing transmissions to one or more receiving devices and/or receive incoming transmissions from one or more sending devices. Controller 210 may be configured to handle processing of signals being transmitted from and received by antenna array 208. Controller 210 may be connected to a network via interface 212. The network may be representative of a public network (e.g., such as the Internet), a private network (e.g., a network that interconnects CBSs), or any other suitable network.

To extend the capabilities of a conventional CBS (e.g., CBS 202) to the airspace above the CBS, enhanced communication environment 200 may utilize one or more RISs 204. Although multiple RISs 204 may be utilized in enhanced communication environment 200, FIG. 2 may only illustrate a single RIS 204 for ease of discussion. An RIS 204 may be representative of an artificial planar structure with integrated electronic circuits that may be programmed to manipulate incoming transmissions in a wide variety of functionalities. As shown, RIS 204 may be positioned on a structure 214. In some embodiments, structure 214 may be representative of one or more of a building, a hill, a water tower, a billboard, and the like. Generally, RIS 204 may be positioned at some position above ground level, but below the positioning of CBS 202. Such positioning may ensure that antenna array 208 of CBS 202 may have a direct line of sight with the RIS 204. In operation, RIS 204 may be configured to reflect downward transmissions from CBS 202 in an upwards direction to AV 206. In this manner, AV 206 may receive a strong signal from CBS 202, despite CBS 202 having a downward facing antenna array 208.

Although enhanced communication environment 200 only shows one CBS 202 and one RIS 204, those skilled in the art understand that such communication environment may include more than one CBS 202 and/or more than one RIS 204. For example, in some embodiments, a communication environment may include a single CBS 202 servicing multiple RISs 204. In some embodiments, a communication environment may include multiple CBSs 202 servicing a single RIS 204. In some embodiments, a communication environment may include multiple CBSs 202 servicing multiple RISs 204.

In some embodiments, RIS 204 may include at least a reconfigurable array 216, an RIS controller 218, and an interface 220. In some embodiments, reconfigurable array 216 may be representative of a two-dimensional array (e.g., a surface). In some embodiments, reconfigurable array 216 may be one-dimensional. In some embodiments, reconfigurable array 216 may be representative of a three-dimensional structure. Although reconfigurable array 216 can be one-dimensional or three-dimensional, for ease of discussion, RIS 204 may be representative of a two-dimensional array.

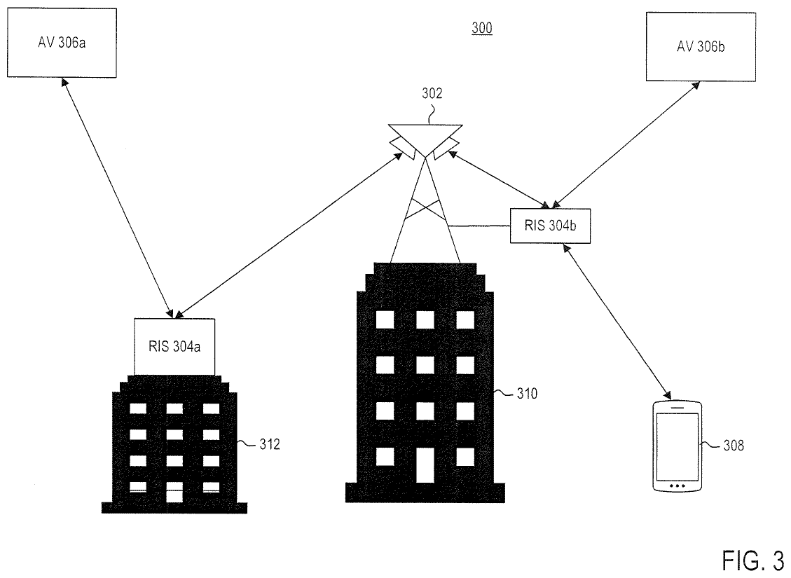

Reconfigurable array 216 may include one or more reflective elements configured to reflect and/or refract transmissions from CBS 202 and a radiation panel. For the purposes of the discussion in FIG. 2, reconfigurable array 216 may be configured to reflect transmissions from CBS 202. The refraction of transmissions from CBS 202 is discussed below in conjunction with FIG. 3. Similarly, reconfigurable array 216 may be further configured to reflect transmissions received from AV 206 to CBS 202. In this manner, reconfigurable array 216 may act as a relay for transmissions between CBS 202 and AV 206. Reconfigurable array 216 may include a plurality of unit elements, with each unit element having tunable reflection properties.

RIS controller 218 may be configured to communicate with CBS controller 210. In some embodiments, RIS controller 218 may be in communication with CBS controller 210 via one or more wired or wireless connections. For example, in some embodiments, RIS controller 218 may be in communication with CBS controller 210 via a wired connection. In such embodiments, RIS 204 may be proximate or closer to CBS 202. In some embodiments, RIS controller 218 may be in wireless communication with CBS controller 210. In such embodiments, RIS 202 may be spaced further from CBS 202, such as on a separate structure or building. In operation, RIS controller 218 may configure or reconfigure elements of reconfigurable array 216 based on instructions received from CBS controller 210. For example, CBS controller 210 may communicate instructions to RIS controller 218 regarding how to configure or reconfigure reflective elements of reconfigurable array 216 to achieve a certain beam shape for the outgoing signals. Based on the instructions, RIS controller 218 can configure or reconfigure a radiation panel of reconfigurable array 216. In this manner, when CBS 202 sends a transmission to RIS 204, RIS 204 can reflect the transmission towards AV 206 in a manner that achieves the dictated beam shape.

During operation, RIS 204 can beam shape the signals being reflected towards AV 206. For example, RIS 204 can provide a wide beam shape, a narrow beam, and any beam shape therebetween. The type of beam provided by RIS 204 may be based on the requirements of AV 206. For example, AV 206 may provide its requirements via channel information that is provided to CBS 202 via RIS 204. For example, CBS 202 may cause RIS 204 to initially cast a wide beam to ensure that the redirected signal is provided to AV 206. After connection is established via RIS 204, CBS 202 may instruct RIS 204 to cast a narrow beam toward AV 206.

In some embodiments, CBS 202 may determine the beam shape for the outgoing signal based on transmissions received from AV 206. For example, in some embodiments, AV 206 may provide feedback to CBS 202 regarding a transmission received from CBS 202 via RIS 204. Based on the feedback provided by AV 206, CBS 202 may optimize the outgoing transmission to RIS 204. In some embodiments, CBS 202 may further provide RIS 204 instructions for further local optimizations. For example, CBS controller 210 may instruct RIS controller 218 regarding the shape of the beam to be provided to AV 206. In this manner, CBS 202 and RIS 204 may work in conjunction to optimize transmissions to AV 206.

In some embodiments, RIS 204 may be representative of an active RIS. An active RIS may refer to an RIS that includes energy-intensive radio-frequency (RF) circuits and consecutive signal processing units embedded therein. In such embodiments, reconfigurable array 216 may be representative of a discrete photonic antenna array. A discrete photonic antenna array may integrate active optical-electrical detectors, converters, and modulators for performing transmission, reception, and conversion of optical or RF signals.

In some embodiments, RIS 204 may be representative of a passive RIS. A passive RIS may act as a passive metal mirror or wave collector, which can be programmed to change an impinging electromagnetic field in a customizable way. Compared to active RISs, a passive RIS may include low-cost and almost passive elements that may not require dedicated power sources. The circuitry and embedded sensors of passive RISs can be powered with energy harvesting modules. In operation, a passive RIS may be used to shape radio waves impinging upon them, and forward the incoming signal without employing any power amplifier or RF chain, or even applying sophisticated signal processing. In some embodiments, a passive RIS may work in full duplex mode without significant self-interferences or increased noise level. Such embodiments are particularly useful to enhanced communication environment 200 in that, due to their extremely low power consumption and hardware costs, passive RISs can be deployed onto building facades, room and factory ceilings, laptop cases, human clothing, etc.

In some embodiments, RIS 204 may be representative of a discrete RIS. A discrete RIS may be representative of a discrete holographic multiple input multiple output surface (HMIMOS). HMIMOS may include a plurality of discrete unit cells made of low-power and software-tunable metamaterials. In some embodiments, the means to electronically modify EM properties of the unit cells may range from electronic components to liquid crystals, microelectromechanical systems, electromechanical switches, or other reconfigurable metamaterials. Such structure is substantially different from a conventional MIMO antenna array. In some embodiments, a discrete RIS may be based on discrete “meta-atoms” with electronically steerable reflection properties. In some embodiments, a discrete RIS may be an active RIS based on photonic antenna arrays.

In some embodiments, RIS 204 may be representative of a contiguous RIS. In some embodiments, a contiguous RIS may include a virtually infinite number of elements placed on a limited surface area to form a spatially continuous transceiver aperture.

As partially indicated above, RIS 204 may be configured to operate in one or more modes, depending on the type of RIS being used. For example, RIS 204 may be configured operate in a reflecting mode, a reflecting and receiving mode, a transmitting and reflecting mode, and an amplifying mode. In the most basic sense, RIS 204 may be configured to operate in a reflecting mode. For example, RIS 204 may be configured to receive and reflect transmissions from CBS 202 to AV 206; similarly, RIS 204 may be configured to receive and reflect transmissions from AV 206 to CBS 202. To reflect incoming transmissions, RIS 204 may be configured to reconfigure the reflection characteristics of its surface elements, thus enabling programmable manipulation of incoming transmissions in a wide variety of functionalities. In some embodiments, to achieve a fine-grained control over the reflected transmissions for quasi-free space beam manipulation to realize accurate beamforming, meta-atoms of sub-wavelength size may be used.

In some embodiments, such as in rich scattering environments, the wave energy may be statistically equally spread throughout the wireless medium. The ensuing ray chaos may imply that rays may impact RIS 204 from all possible directions, rather than one well-defined direction. As such, RIS 204 may be configured to manipulate as many ray paths as possible, instead of creating a directive beam. This manipulation may have two goals: tailoring those rays to create constructive interference at a target location and stirring the field efficiently. These manipulations may be efficiently realized with RISs equipped with half-wavelength-sized meta-atoms, enabling the control of more rays with a fixed amount of electronic components (e.g., PIN diodes).

In some embodiments, RIS 204 may be configured to simultaneously reflect a portion of an impinging signal in a programmable way, while another portion of the impinging signal can be fed to a sensing unit of RIS 204. In such embodiments, RIS 204 may include a waveguide coupled to each of its meta-atoms. In some embodiments, each waveguide may be connected to an RF chain of RIS 204. Such arrangement may assist in locally processing a portion of the received signals in the digital domain.

In some embodiments, RIS 204 may include mushroom structures, each loaded with a varactor diode. Such reconfigurable capacitance may result in a reconfigurable resonance frequency, and consequently, a reconfigurable effective impedance. Such element can provide a simple mechanism to realize high reflectivity with reconfigurable phases. In some embodiments, to address each meta-atom independently, as required for forming desired refection patterns, the via of the mushroom structure may extend through the bottom conductive plate of RIS 204. In some embodiments, an annular slot may separate the via from the ground plane beneath the substrate. This annular slot may allow for coupling the incident wave to another layer.

In some embodiments, RIS 204 may operate in a reflecting and refracting (or transmitting) mode. In reflecting and refracting mode, RIS 204 may allow wireless signals incident on the surface to be simultaneously reflected and transmitted. In this manner, RIS 204 can assist in achieving a full-space reconfigurable wireless environment that has a 360-degree coverage by servicing user equipment below RIS 204 and AVs above RIS 204 and CBS 202. Further details of the reflecting and refracting mode are discussed below in conjunction with FIG. 3.

In some embodiments, RIS 204 may operate in an amplification mode. In such embodiments, RIS 204 may include a power amplifier. Such power amplifier may allow RIS 204 to amplify reflected signals. In operation, the impinging signal from CBS 202 may be received by a portion of RIS 204. The received EM field may be phase configured and fed to the power amplifier. The power amplifier may, in turn, feed the received EM field to the remaining portion of RIS 204 that reflects the signal with controllable phase configuration.

FIG. 3 illustrates an enhanced communication environment 300, according to example embodiments. Enhanced communication environment 300 may include CBS 302, a RIS 304a, a RIS 304b, an AV 306a, an AV 306b, and user equipment 308. As shown, CBS 302 may be positioned on a structure 310, similar to CBS 202 in FIG. 2. Similarly, RIS 304a may be positioned on a structure 312, similar to RIS 204 in FIG. 2.

As shown, RIS 304a may be configured to service CBS 302. For example, RIS 304a may be representative of a fully reflective RIS configured to reflect transmissions received from CBS 302 to AV 306a. Similarly, RIS 304a may be configured to reflect transmissions received from AV 306a to CBS 302. In other words, CBS 302, RIS 304a, and AV 306a may work similarly to CBS 202, RIS 204, and AV 206 discussed above, in conjunction with FIG. 2.

In some embodiments, RIS 304b may also service CBS 302. For example, RIS 304b may be representative of an RIS configured to operate in a reflective and refractive mode. In such embodiments, RIS 304b should be positioned in a manner such that RIS 304b can transmit or refract transmissions from CBS 302 in a downward manner. In other words, RIS 304b may be positioned beneath CBS 302, but in a manner that does not block the transmission or refraction of transmissions to ground users (e.g., user equipment 308).

As shown, CBS 302 may utilize RIS 304b to reflect transmission in an upward direction to AV 306b. Similarly, RIS 304b may reflect transmissions from AV 306b to CBS 302. CBS 302 may also utilize RIS 304b to refract transmissions down to user equipment 308. In some embodiments, RIS 304b may simultaneously reflect and refract transmissions to AV 306b and user equipment 308. In this manner, RIS 304b can provide full 360-degree coverage for both aerial equipment (e.g., AV 306b) and ground equipment (e.g., user equipment 308).

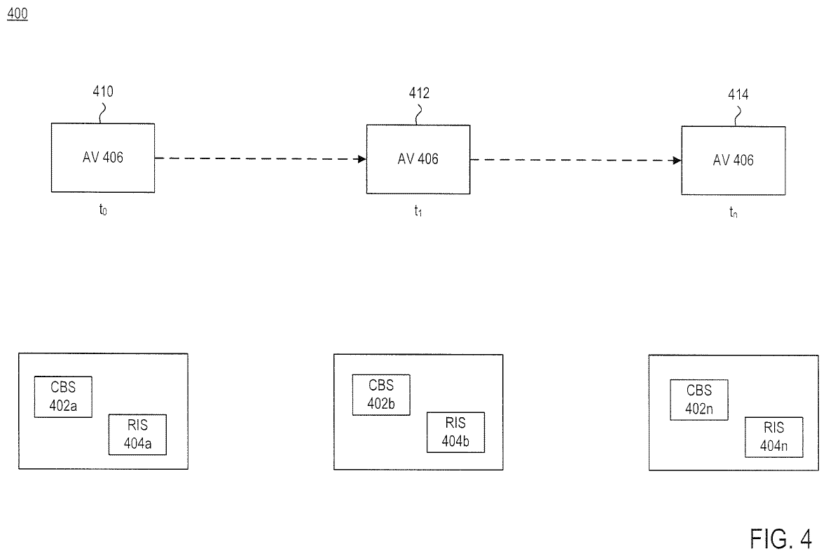

FIG. 4 is an illustrative schematic of an enhanced communication environment 400 over time, according to example embodiments. As shown, an enhanced communication environment 400 may include multiple CBSs 402a, 402b, and 402n and their associated RISs 404a, 404b, and 404n. As shown, an AV 406 may occupy different locations in the airspace at various times. For example, at time t₀, AV 406 may be at a first position 410; at time t₁, AV 406 may be at a second position 412; and at time tₙ, AV 406 may be at an nth position 414. Similar to CBS handover procedures for ground users, a given CBS may handover control to another CBS based on received power measurements from AV 406.

For example, at time t₀, AV 406 may be initially serviced by CBS 402a and RIS 404a. In other words, CBS 402a may transmit signals to RIS 404a to be optimized and/or reflected to AV 406. In some embodiments, AV 406 may report back to CBS 402a a power measurement of the received signal. AV 406 may communicate that information by transmitting a signal to RIS 404a that will be reflected to CBS 402b.

At time t₁, the power of the signal from CBS 402a may be suboptimal. In such situations, enhanced communication environment 400 may facilitate a handover from CBS 402a to CBS 402b. Accordingly, in subsequent communications, AV 406 may send and/or receive signals from CBS 402b via RIS 404b.

At time tₙ, the power of the signal from CBS 402b may be suboptimal. In such situations, enhanced communication environment 400 may facilitate a handover from CBS 402b to CBS 402c. Accordingly, in subsequent communications, AV 406 may send and/or receive signals from CBS 402c via RIS 404c.

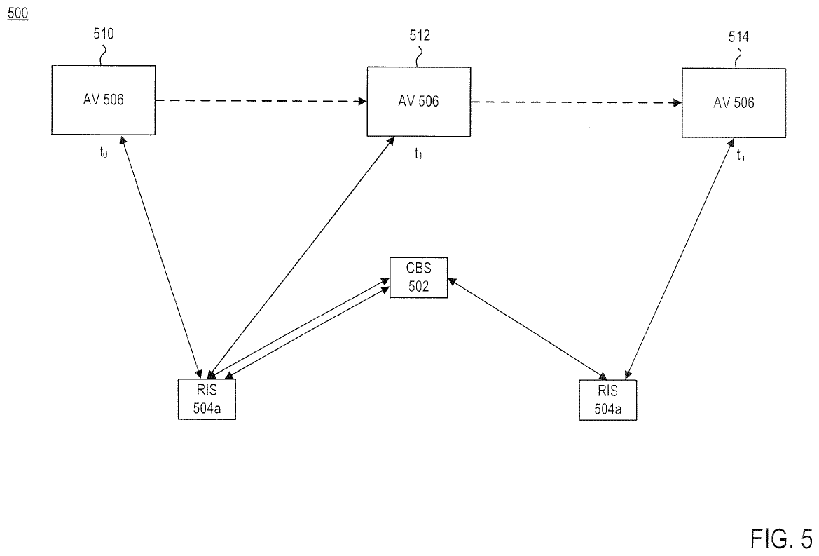

FIG. 5 is an illustrative schematic of an enhanced communication environment 500 over time, according to example embodiments.

In some embodiments, such as that discussed in FIG. 5, a given CBS may service two or more RISs. In some embodiments, CBS may transmit signals to each RIS simultaneously using multiplexing techniques. As shown, enhanced communication environment 500 may include CBS 502, RISs 504a, RIS 504b, and AV 506. As shown, AV 506 may occupy different locations in the airspace at various times. For example, at time t₀, AV 506 may be at a first position 510; at time t₁, AV 506 may be at a second position 512; and at time tₙ, AV 506 may be at an nth position 514.

In some embodiments, CBS 502 may initially utilize RIS 504a for servicing AV 506. For example, at time t₀, CBS 502 may transmit a signal to RIS 504 to be optimized and reflected towards AV 506.

In some embodiments, CBS 502 may similarly utilize 504a for servicing AV 506. For example, at time t₁, CBS 502 may transmit a signal to RIS 504 to be optimized and reflected towards AV 506.

At time tₙ, AV 506 has moved to position 514. In some embodiments, between time t₁ and tₙ, AV 506 may have reported back to CBS 502 a power measurement of the received signal. AV 506 may communicate that information by transmitting a signal to the RIS 504a that was reflected to CBS 502. Based on this information, rather than changing CBSs, CBS 502 may utilize RIS 504b to communicate with AV 506 at position 514. For example, at time tₙ, CBS 502 may transmit a signal to RIS 504b to be optimized and reflected towards AV 506.

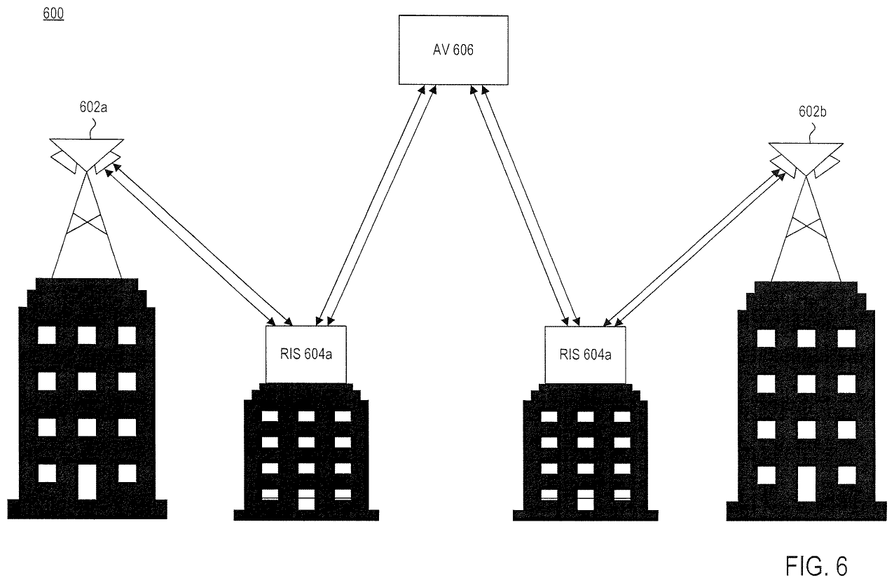

FIG. 6 is an illustrative schematic of enhanced communication environment 600, according to example embodiments.

As shown, enhanced communication environment 600 may include CBS 602a, CBS 602b, RIS 604A, RIS 604b, and AV 606. In some embodiments, multiple CBSs (e.g., CBS 602a and CBS 602b) may simultaneously attempt to communicate with AV 606. The illustrative schematic shown in FIG. 6 illustrates an interference mitigation scheme to improve the spectral efficiency in the sky. As shown, CBS 602a may refer to the active CBS that is the current source of communication with AV 606; CBS 602b may refer to the interfering CBS that is attempting to also communicate with AV 606, thus potentially causing interference with the communications from CBS 602a.

As those skilled in the art understand, a CBS (e.g., CBS 602a and CBS 602b) may include a high powered main lobe and one or more low powered side lobes. When communicating with AV 606, CBS 602a may transmit a signal from its high powered main lobe. Similarly, when communicating with AV 606, CBS 602b may transmit a signal from its high powered main lobe.

In some embodiments, in addition to, or in lieu of, the optimization at the CBS, RIS 604a may perform a local optimization to adjust the signal from the low powered side lobe in a manner that will constructively interfere with the signal from the high powered main lobe.

To mitigate interference between CBS 602a and CBS 602b, a controller of CBS 602a may transmit a signal from its low powered side lobe with the signal from its high powered main lobe. The signal from the low powered side lobe may be optimized by the controller to constructively interfere with the signal from the high powered main lobe. In such manner, CBS 602 may transmit an amplified signal to AV 606.

In some embodiments, CBS 602b may also take steps to mitigate interference with CBS 602a. For example, a controller of CBS 602b may transmit a signal from its low powered side lobe with the signal from its high powered main lobe. The signal from the low powered side lobe may be optimized by the controller to destructively interfere with the signal from the high powered main lobe. In such manner, the signal from the low powered side lobe may cancel out the signal from the high powered main lobe.

In some embodiments, in addition to, or in lieu of, the optimization at the CBS, RIS 604b may perform a local optimization to adjust the signal from the low powered side lobe in a manner that will destructively interfere with the signal from the high powered main lobe.

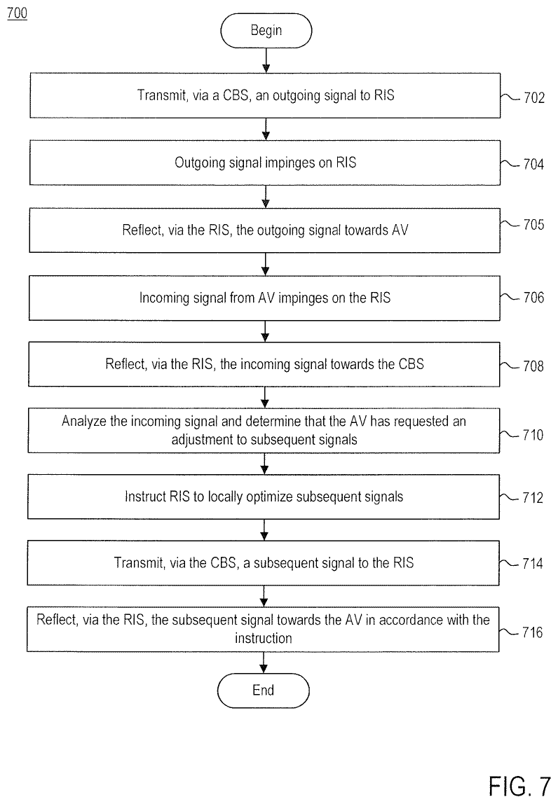

FIG. 7 is a flow diagram illustrating a method 700 of communication between a CBS and an AV, according to example embodiments. FIG. 7 can be implemented in any communication environment, such as, but not limited to, the communication environments discussed above in conjunction with FIGS. 2-6. For purposes of discussion, method 700 may discuss such communication process with respect to components of enhanced communication environment 200.

Method 700 may begin at step 702. At step 702, CBS 202 may transmit a signal to AV 206. To transmit a signal to AV 206, CBS 202 may transmit the signal to RIS 204.

At step 704, an outgoing signal from CBS 202 may impinge on RIS 204. The outgoing signal may be destined for AV 206.

At step 705, RIS 204 may reflect the signal towards AV 206. In some embodiments, RIS 204 may locally optimize the signal before reflection. For example, RIS 204 may beam shape and/or amplify the received transmission for reflection to AV 206.

At step 706, the incoming signal impinges on RIS 204. The incoming signal may be destined for CBS 202. In some embodiments, the incoming signal may include a request for optimizing subsequent communications from CBS 202. In some embodiments, the incoming signal may include communications to be transmitted to another device or party. In some embodiments, RIS 204 may be configured with reception circuitry and/or software and hardware 12 components for signal processing. Accordingly, RIS 204 may have computational autonomy. In such embodiments, RIS 204 may measure and/or estimate features of the impinging incoming signal. In this manner, RIS 204 can be configured to optimize its reconfigurable panel with minimal interaction with CBS 202.

At step 708, RIS 204 may reflect the incoming signal from AV 206 to CBS 202.

At step 710, CBS 202 may analyze the incoming signal and determine that AV 206 has requested an adjustment to subsequent signals. For example, in some embodiments, AV 206 may request a stronger signal. In another example, AV 206 may request a specific beam shape.

At step 712, CBS 202 may instruct RIS 204 to locally optimize subsequent signals based on the request. For example, CBS controller 210 may communicate instructions to RIS controller 218 that may cause RIS controller 218 to amplify subsequent signals from CBS 202 and/or configure reconfigurable array panel 216 to change the manner in which RIS 204 reflects signals from CBS 202.

At step 714, CBS 202 may transmit a subsequent signal to RIS 204.

At step 716, RIS 204 may reflect the signal towards AV 206 in accordance with the instructions received from CBS controller 210. In some embodiments, RIS 204 may amplify the signal prior to reflecting the signal to AV 206. In some embodiments, RIS 204 may reflect the signal after configuring reconfigurable array 216 in accordance with the instructions.

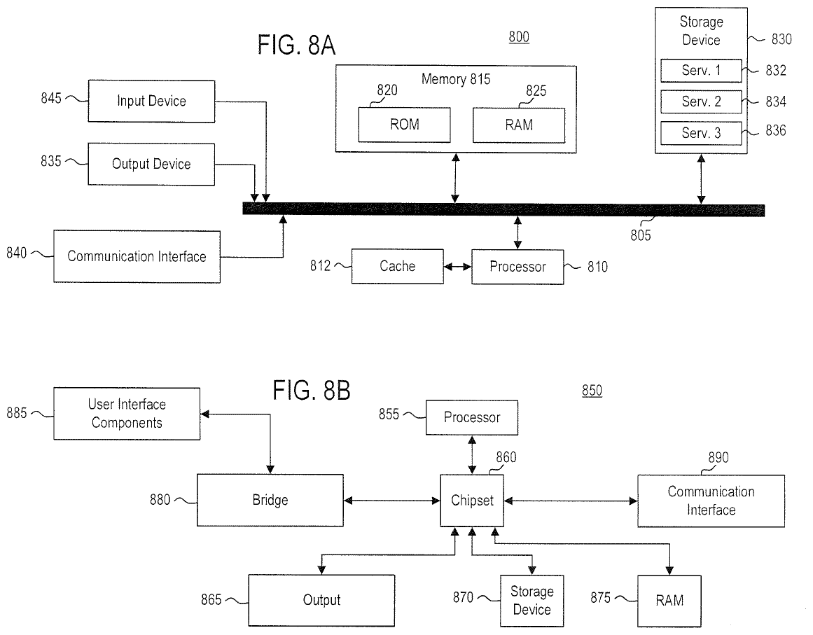

FIG. 8A illustrates an architecture of system bus computing system 800, according to example embodiments. Computing system 800 may be representative of CBS controller 210 and/or RIS controller 218. One or more components of system 800 may be in electrical communication with each other using a bus 805. System 800 may include a processor (e.g., one or more CPUs, GPUs or other types of processors) 810 and a system bus 805 that couples various system components including the system memory 815, such as read only memory (ROM) 820 and random access memory (RAM) 825, to processor 810. System 800 can include a cache of high-speed memory connected directly with, in close proximity to, or integrated as part of, processor 810. System 800 can copy data from memory 815 and/or storage device 830 to cache 812 for quick access by processor 810. In this way, cache 812 may provide a performance boost that avoids processor 810 delays while waiting for data. These and other modules can control or be configured to control processor 810 to perform various actions. Other system memory 815 may be available for use as well. Memory 815 may include multiple different types of memory with different performance characteristics. Processor 810 may be representative of a single processor or multiple processors. Processor 810 can include one or more of a general purpose processor or a hardware module or software module, such as service 1 832, service 2 834, and service 3 836 stored in storage device 830, configured to control processor 810, as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the system 800, an input device 845 can be any number of input mechanisms, such as a microphone for speech, a touch-sensitive screen for gesture or graphical input, keyboard, mouse, motion input, speech and so forth. An output device 835 (e.g., a display) can also be one or more of a number of output mechanisms known to those of skill in the art. In some instances, multimodal systems can enable a user to provide multiple types of input to communicate with system 800. Communication interface 840 can generally govern and manage the user input and system output. There is no restriction on operating on any particular hardware arrangement, and therefore the basic features here may easily be substituted for improved hardware or firmware arrangements as they are developed.

Storage device 830 may be a non-volatile memory and can be a hard disk or other type of computer readable media that can store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 can include services 832, 834, and 836 for controlling the processor 810. Other hardware or software modules are contemplated. Storage device 830 can be connected to system bus 805. In one aspect, a hardware module that performs a particular function can include the software component stored in a computer-readable medium in connection with the necessary hardware components, such as processor 810, bus 805, output device 835 (e.g., a display), and so forth, to carry out the function.

FIG. 8B illustrates a computer system 850 having a chipset architecture, according to example embodiments. Computer system 850 may be representative of CBS controller 210 and/or RIS controller 218. Computer system 850 may be an example of computer hardware, software, and firmware that can be used to implement the disclosed technology. System 850 can include one or more processors 855, representative of any number of physically and/or logically distinct resources capable of executing software, firmware, and hardware configured to perform identified computations. One or more processors 855 can communicate with a chipset 860 that can control input to and output from one or more processors 855. In this example, chipset 860 outputs information to output 865, such as a display, and can read and write information to storage device 870, which can include magnetic media, and solid-state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 855 analyzing data stored in storage device 870 or RAM 875. Further, the machine can receive inputs from a user through user interface components 885 and execute appropriate functions, such as browsing functions by interpreting these inputs using one or more processors 855.

It can be appreciated that example systems 800 and 850 can have more than one processor 810, 855 or be part of a group or cluster of computing devices networked together to provide greater processing capability.

While the foregoing is directed to embodiments described herein, other and further embodiments may be devised without departing from the basic scope thereof. For example, aspects of the pre-sent disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readable by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the dis-closed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is there-fore intended that the following appended claims include all such modifications, permutations, and equivalents as fall within the true spirit and scope of these teachings.

1. A communication system, comprising:
a cellular base station comprising a downward facing antenna array and a first controller, the cellular base station configured to communicate with a first user equipment above the cellular base station; and
a reconfigurable intelligent surface positioned below the cellular base station, the reconfigurable intelligent surface comprising a reconfigurable panel of reflecting elements and a second controller, the reconfigurable intelligent surface configured to service the first user equipment by reflecting signals from the cellular base station to the first user equipment.

2. The communication system of claim 1, wherein the first controller is in communication with the second controller via a wired connection.

3. The communication system of claim 1, wherein the first controller is in communication with the second controller via a wireless connection.

4. The communication system of claim 1, wherein the reconfigurable intelligent surface is configured to reflect incoming signals from the first user equipment to the cellular base station.

5. The communication system of claim 4, wherein the first controller is configured to analyze the incoming signals to identify a request from the first user equipment.

6. The communication system of claim 5, wherein the first controller is configured to instruct the second controller to configure a planar array to change a manner in which the reconfigurable intelligent surface reflects the signals to the first user equipment based on the request.

7. The communication system of claim 6, wherein the first controller instructs the second controller to amplify the signals before reflection based on the request.

8. The communication system of claim 6, wherein the first controller instructs the second controller to configure the reconfigurable panel to change a beam shape of the reflected signals.

9. The communication system of claim 1, wherein the cellular base station is further configured to communicate with a second user equipment below the cellular base station.

10. The communication system of claim 9, wherein the reconfigurable intelligent surface is configured to simultaneously service the first user equipment and the second user equipment.

11. The communication system of claim 10, wherein the reconfigurable intelligent surface is configured to reflect first signals upwards towards the first user equipment and refract second signals downward towards the second user equipment.

12. The communication system of claim 9, wherein the reconfigurable intelligent surface comprises a partially transparent body.

13. The communication system of claim 1, further comprising:
a second cellular base station configured to communicate with the first user equipment.

14. The communication system of claim 13, wherein the cellular base station is configured to handoff communication with the first user equipment to the second cellular base station based on feedback from the first user equipment.

15. The communication system of claim 1, further comprising:
a second reconfigurable intelligent surface positioned below the cellular base station.

16. The communication system of claim 15, wherein the cellular base station is configured to handoff communication with the first user equipment from the reconfigurable intelligent surface to the second reconfigurable intelligent surface.

17. A method of communicating with an aerial vehicle, comprising:
transmitting, by a cellular base station, a first signal to a reconfigurable intelligent surface positioned below the cellular base station;
reflecting, by the reconfigurable intelligent surface, the first signal towards the aerial vehicle;
receiving, by the reconfigurable intelligent surface, a second signal from the aerial vehicle; and
reflecting, by the reconfigurable intelligent surface, the second signal to the cellular base station.

18. The method of claim 17, further comprising:
directly transmitting, by the cellular base station, a third signal to a ground user.

19. The method of claim 17, further comprising:
transmitting, by the cellular base station, a third signal to the reconfigurable intelligent surface; and
refracting, by the reconfigurable intelligent surface, the third signal to a ground user.

20. The method of claim 17, further comprising:
receiving, by the cellular base station, the second signal from the reconfigurable intelligent surface;
analyzing, by the cellular base station, the second signal to determine that the aerial vehicle requested a desired beam shape for subsequent signals;
instructing, by the cellular base station, the reconfigurable intelligent surface to adjust a reconfigurable panel of reflective elements to achieve the desired beam shape;
transmitting, by the cellular base station, a subsequent signal to the reconfigurable intelligent surface; and
reflecting, by the cellular base station, the subsequent signal towards the aerial vehicle in accordance with the desired beam shape.
